(19) United States
(12) Patent Application Publication
(10) Pub. No.: US 2020/0379080 A1
(43) Pub. Date: Dec. 3, 2020

(54) LOCATION ESTIMATION SYSTEM, LOCATION ESTIMATION METHOD, AND PROGRAM

(71) Applicant: NEC Corporation, Minato-ku, Tokyo (JP)

(72) Inventor: Jun SAKAI, Tokyo (JP)

(73) Assignee: NEC Corporation, Minato-ku, Tokyo (JP)

(21) Appl. No.: 16/766,487

(22) PCT Filed: Nov. 28, 2018
(86) PCT No.: PCT/JP2018/043702

§ 371 Date: May 22, 2020

(30) Foreign Application Priority Data
Nov. 29, 2017 (JP) 2017-228827

(51) Int. Cl. G01S 5/14; G01S 5/02

(52) U.S. Cl. CPC G01S 5/145; G01S 5/0269; G01S 5/0244

(57) ABSTRACT

A location estimation system includes a location estimation part that estimates a location of a radio wave transmission source by using radio wave strengths received by a plurality of radio wave sensors dispersedly placed in a predetermined area, propagation models, each of which represents a relationship between radio wave strengths and distance, and probability distribution models of the radio wave strengths. The location estimation part in the location estimation system estimates the location of the radio wave transmission source by using a propagation model set for an individual sub-area obtained by dividing the predetermined area based on locations of the radio wave sensors in the predetermined area and placement of an obstacle(s) in the predetermined area.

### FIELD

### Reference to Related Application

The present invention is based upon and claims the benefit of the priority of Japanese patent application No. 2017-228827, filed on Nov. 29, 2017, the disclosure of which is incorporated herein in its entirety by reference thereto.

The present invention relates to a location estimation system, a location estimation method, and a program.

### BACKGROUND

Recent advancement and spread of radio technology have been depleting frequency resources, and it is becoming more and more important to effectively utilize the frequency in the time, space, and frequency domains. Thus, generally, radio wave monitoring organizations of various countries have assigned frequencies to radio users, and radio waves are used within a permitted range of frequencies or radio wave strengths. However, there are illegal radio stations that use radio waves without acquiring radio station licenses, and these illegal radio stations transmit radio waves with an excessively large output. As a result, there are problems of radio wave interference and communication failure. To address these problems, Ministry of Internal Affairs and Communications of Japan has deployed a radio wave monitoring system (Detect Unlicensed Radio Stations: DEURAS) across the country, to achieve proper use of radio waves by measuring the strengths and arrival directions of the radio waves and estimating the locations of the illegal radio stations.

As a method for estimating the location of a radio wave transmission source, there is a method using the direction of arrival (DoA) discussed in NPL 1, for example. There is also a method that uses a received signal strength indicator (RSSI) as discussed in NPL 2 and PTL 1. In addition, there is proposed a method using the time difference of arrival (TDoA) of radio waves received by a plurality of radio wave sensors. As a technique in which these methods are combined, PTL 2 proposes a method for performing location estimation by previously modeling information about an individual propagation path from an arbitrary location in a target area to an individual radio wave sensor by using a ray tracing simulation and utilizing cross-correlation of the propagation path information and cross-correlation of signals actually received by a plurality of radio wave sensors.

PTL 3 discloses a location estimation method that can estimate a location of a search target person or object under a simple system configuration while reducing the impact caused by the fluctuation of received radio wave strengths. According to this publication, a single transmitter 10 and a single portable terminal 12 are used. This portable terminal 12 includes radio wave measuring means for receiving radio waves transmitted by the transmitter 10 and measuring the received radio wave strengths and location measuring means for measuring the location of the portable terminal 12. According to this publication, this portable terminal 12 is moved to different locations, and the radio wave strengths received from the transmitter 10 and the location of the receiving-end portable terminal 12 are measured at the different locations. PTL 3 discloses estimating the location of the transmitter 10 by repeating the above processing and integrating the received radio wave strengths and the receiving-end location information obtained as the measurement results at the multiple points.

NPL 3 is a guideline for evaluation of radio interface technologies for International Mobile Telecommunications (IMT)-Advanced of the International Telecommunication Union (ITU).

### CITATION LIST

### Patent Literature

PTL 1: Japanese Patent Kokai Publication No. JP2015-158492A
PTL 2: Japanese Patent No. JP6032462
PTL 3: Japanese Patent Kokai Publication No. JP2017-142180A

### Non Patent Literature

NPL 1: Ministry of Internal Affairs and Communications, The Radio Use Web Site, Radio Monitoring System, [online], [searched on Nov. 9, 2017], Internet
<URL:http://www.tele.soumu.go.jp/j/adm/monitoring/moni/type/deurasys/>

### NPL 2: Shinsuke HARA: Statistical Estimation Theory in Localization, IEICE Fundamentals Review, 4-1, 32/38 (2010)

NPL 3: Report ITU-R, M.2135-1, “Guidelines for evaluation of radio interface technologies for IMT-Advanced”, International Telecommunication Union, 2012.

### SUMMARY

### Technical Problem

The following analysis has been given by the present inventor. When a radio wave is blocked, reflected, or diffracted by an obstacle, it is known that the strength of the radio wave is made less than that of a radio wave that goes straight ahead, the time of arrival of the radio wave fluctuates, or the direction of arrival of the radio wave changes. In particular, if the radio wave frequency is increased, the attenuation of the radio wave distance is increased. In addition, if the straightness is increased, the number of diffracted waves is reduced. As a result, since the number of reflected waves that arrive at a radio wave sensor is reduced, the fluctuation caused when radio waves are blocked, reflected, or diffracted becomes larger than that caused when radio waves go straight ahead. Thus, according to the techniques using the DoA, RSSI, TDoA, etc., the location estimation accuracy is deteriorated particularly in urban areas including tall buildings, etc.

In view of these circumstances, PTL 2 proposes a method for reducing the deterioration of the location estimation accuracy even in a multipath environment. However, according to the method in PTL 2, since a ray tracing simulation is performed on the entire target area, the method has problems in that a significantly large operation amount is needed and accurate terrain information and building models are needed. In addition, according to the method in PTL 2, since cross-correlation of received data is calculated, the method has a problem in that the data transfer amount is significantly large.

According to the method in PTL 3, when performing the location estimation, the portable terminal 12 needs to move and perform the measurement. In addition, the method in PTL 3 does not take into consideration the fact that an obstacle between the portable terminal 12 and the transmitter 10 changes the propagation characteristics.

It is an object of the present invention to provide a location estimation system, a location estimation method, and a program that can contribute to broadening means for estimating the location of a radio wave transmission source, the means being suitably usable even in multipath environments such as in which urban areas including tall buildings.

### Solution to Problem

According to a first aspect, there is provided a location estimation system, including a location estimation part that estimates a location of a radio wave transmission source by using radio wave strengths received by a plurality of radio wave sensors dispersedly placed in a predetermined area, propagation models, each of which represents a relationship between radio wave strengths and distance, and probability distribution models of the radio wave strengths. The location estimation part in the location estimation system estimates the location of the radio wave transmission source by using a propagation model set for an individual sub-area obtained by dividing the predetermined area based on locations of the radio wave sensors in the predetermined area and placement of an obstacle(s) in the predetermined area.

According to a second aspect, there is provided a location estimation system in a second mode. The location estimation part in the location estimation system estimates the distance between the radio wave transmission source and the individual radio wave sensor by using a probability distribution model for an individual sub-area obtained by dividing the predetermined area based on placement of an obstacle(s) in the predetermined area. In addition, the location estimation part estimates the location of the radio wave transmission source based on a relative position of the radio wave transmission source estimated by using the plurality of radio wave sensors.

According to a third aspect, there is provided a method for estimating a location of a radio wave transmission source, the method including: causing a computer, which estimates a location of a radio wave transmission source by using radio wave strengths received by a plurality of radio wave sensors dispersedly placed in a predetermined area, propagation models, each of which represents a relationship between radio wave strengths and distance, and probability distribution models of the radio wave strengths, to estimate a location of a radio wave transmission source by using a propagation model set for an individual sub-area obtained by dividing the predetermined area based on locations of the radio wave sensors in the predetermined area and placement of an obstacle(s) in the predetermined area. The present method is associated with a certain machine referred to as a computer that functions as a location estimation system.

According to a fourth aspect, there is provided a program, causing a computer, which estimates a location of a radio wave transmission source by using radio wave strengths received by a plurality of radio wave sensors dispersedly placed in a predetermined area, propagation models, each of which represents a relationship between radio wave strengths and distance, and probability distribution models of the radio wave strengths, to perform processing for estimating a location of a radio wave transmission source by using a propagation model set for an individual sub-area obtained by dividing the predetermined area based on locations of the radio wave sensors in the predetermined area and placement of an obstacle(s) in the predetermined area. This program can be recorded in a computer-readable (non-transient) storage medium. Namely, the present invention can be embodied as a computer program product.

### Advantageous Effects of Invention

The present invention can contribute to broadening means for estimating the location of a radio wave transmission source, the means being suitably usable even in multipath environments. Namely, the present invention provides a location estimation system having a broader application than that of the location estimation systems described in Background.

### BRIEF DESCRIPTION OF THE DRAWINGS

FIG. 1 illustrates a configuration according to an exemplary embodiment of the present invention.

FIG. 2 illustrates a geometric location estimation technique in PTL 3.

FIG. 3 illustrates a location estimation technique according to an exemplary embodiment of the present invention.

FIG. 4 illustrates an overall configuration according to a first exemplary embodiment of the present invention.

FIG. 5 illustrates a flow of estimating the location of a radio wave transmission source by a server according to the first exemplary embodiment of the present invention.

FIG. 6 illustrates an example of division of a target area according to the first exemplary embodiment of the present invention.

FIG. 7 illustrates another example of the division of the target area according to the first exemplary embodiment of the present invention.

FIG. 8 illustrates measurement results of radio wave reception strengths and distance in a sub-area and a propagation model and a probability distribution.

FIG. 9 illustrates an example of a probability density distribution (Rayleigh fading) used in the first exemplary embodiment of the present invention.

FIG. 10 illustrates a method for creating a joint likelihood distribution.

FIG. 11 illustrates a flow of estimating the location of a radio wave transmission source by a server according to a second exemplary embodiment of the present invention.

FIG. 12 illustrates a flow of estimating the location of a radio wave transmission source by a server according to a third exemplary embodiment of the present invention.

FIG. 13 illustrates an example of division of a target area according to a fourth exemplary embodiment of the present invention.

FIG. 14 illustrates another example of the division of the target area according to the fourth exemplary embodiment of the present invention.

FIG. 15 illustrates another example of the division of the target area according to the fourth exemplary embodiment of the present invention.

FIG. 16 illustrates a flow of estimating the location of a radio wave transmission source by a server according to a fifth exemplary embodiment of the present invention.

FIG. 17 illustrates an example of division of a target area according to the fifth exemplary embodiment of the present invention target area.

FIG. 18 illustrates a configuration of a computer that functions as a server according to any one of the exemplary embodiments of the present invention.

### MODES

First, an outline of an exemplary embodiment of the present invention will be described with reference to drawings. Reference characters in the following outline denote various elements for the sake of convenience and are used as examples to facilitate understanding of the present invention. Namely, the description of the outline is not intended to limit the present invention to the illustrated modes. An individual connection line between blocks in an individual drawing, etc. referred to in the following description signifies both one-way and two-way directions. An arrow schematically illustrates a principal signal (data) flow and does not exclude bidirectionality. While a port or an interface exists at an input-output connection point of an individual block in an individual drawing, illustration of the port or the interface will be omitted.

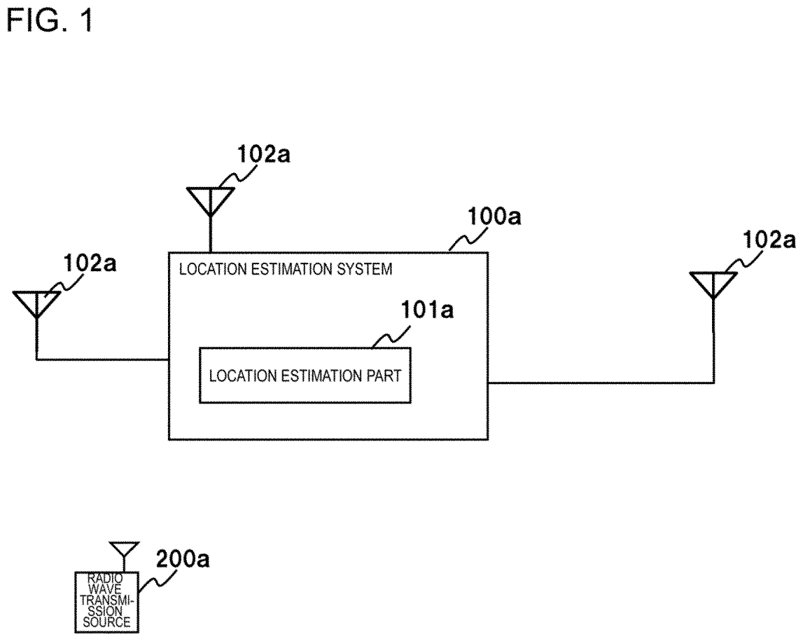

As illustrated in FIG. 1, an exemplary embodiment of the present invention can be realized by a configuration including a plurality of radio wave sensor 102a dispersedly placed in a predetermined area and a location estimation system 100a. The location estimation system 100a includes a location estimation part 101a. The location estimation part 101a estimates the location of a radio wave transmission source 200a by using radio wave strengths received by the radio wave sensors 102a, propagation models, each of which represents a relationship between the radio wave strengths and distance, and probability distribution models of the radio wave strengths.

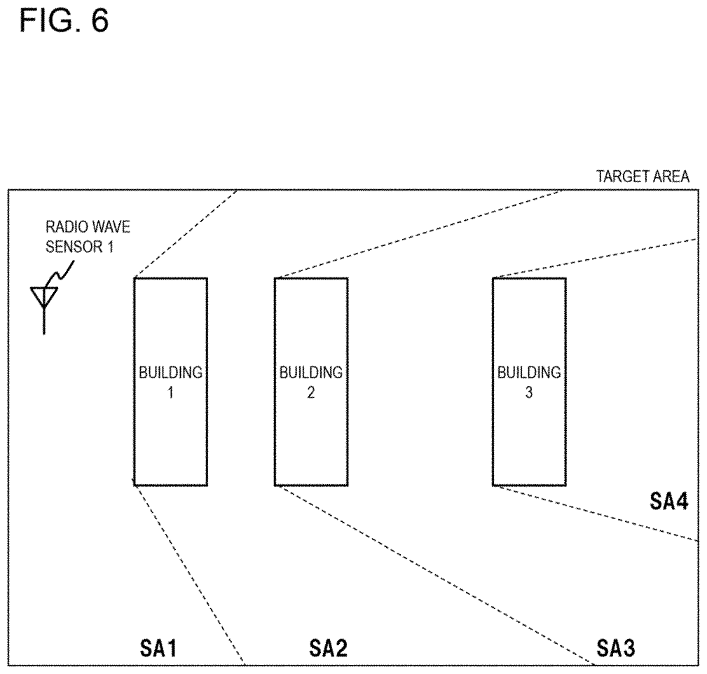

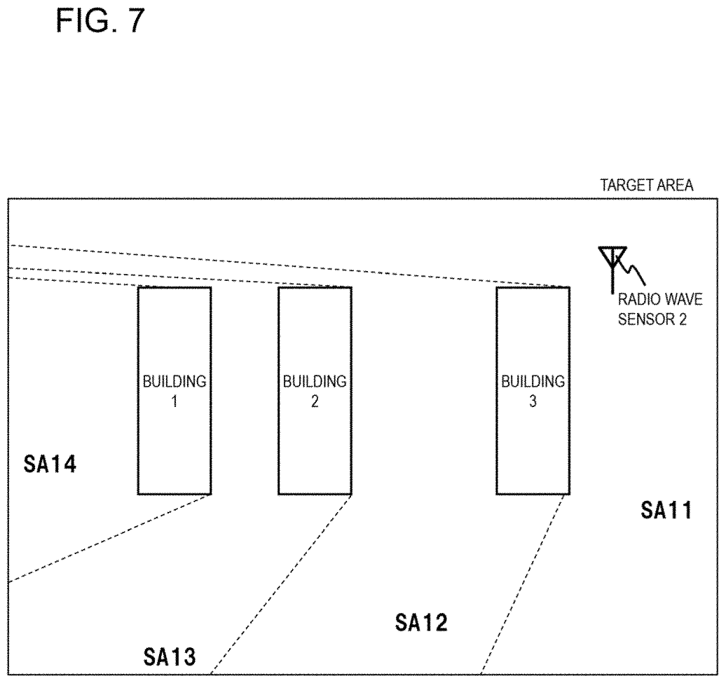

More specifically, the predetermined area is divided into a plurality of sub-areas based on the locations of the radio wave sensors in the predetermined area and the placement of an obstacle(s) in the predetermined area (see SA1 to SA4 in FIG. 6 and SA11 to SA14 in FIG. 7). In addition, the location estimation part 101a estimates the location of the radio wave transmission source 200a by using the propagation models of the respective sub-areas.

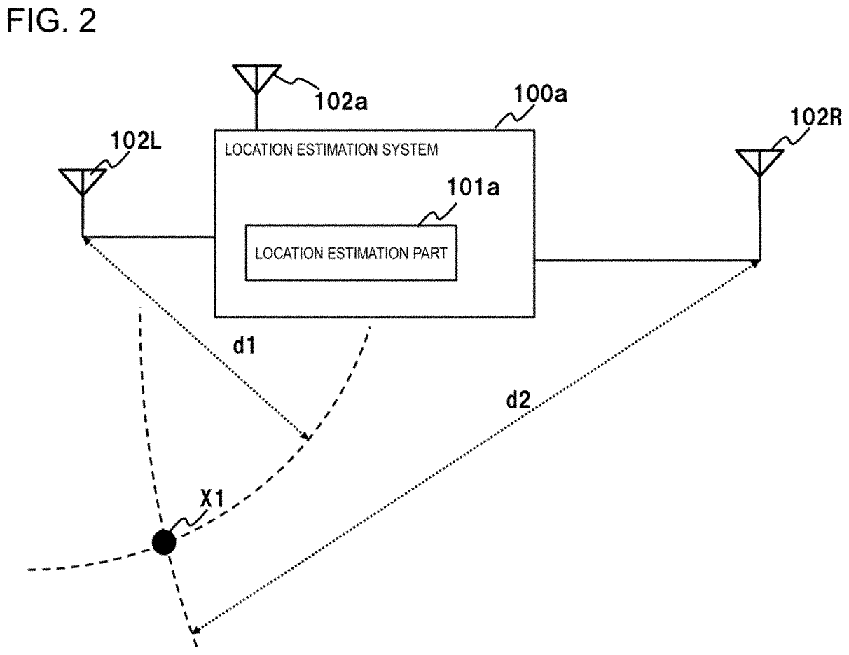

For example, by using the propagation models of the respective sub-areas, the location estimation part 101a can estimate the distance between an individual one of the radio wave sensors 102a and the radio wave transmission source 200a. In addition, the location estimation part 101a estimates the location of the radio wave transmission source 200a based on the distance between an individual one of the radio wave sensors 102a and the radio wave transmission source 200a, the distance having been estimated by using a corresponding one of the plurality of radio wave sensors 102a. The following description assumes estimation of the location of the radio wave transmission source 200a in FIG. 1. According to the geometric technique disclosed in PTL 3, when the location estimation part 101a receives an unknown radio wave from a radio wave sensor 102L on the left side in FIG. 2, the location estimation part 101a can estimate a distance d1 between the radio wave sensor 102L and the radio wave transmission source 200a from the reception strength of the unknown radio wave. Likewise, when the location estimation part 101a receives an unknown radio wave from a radio wave sensor 102R on the right side in FIG. 2, the location estimation part 101a can estimate a distance d2 between the radio wave sensor 102R and the radio wave transmission source 200a from the reception strength of the unknown radio wave. Namely, the location estimation part 101a estimates that the radio wave transmission source 200a exists at an intersection point X1 of a circuit having a radius of d1 from the radio wave sensor 102L and a circle having a radius of d2 from the radio wave sensor 102R.

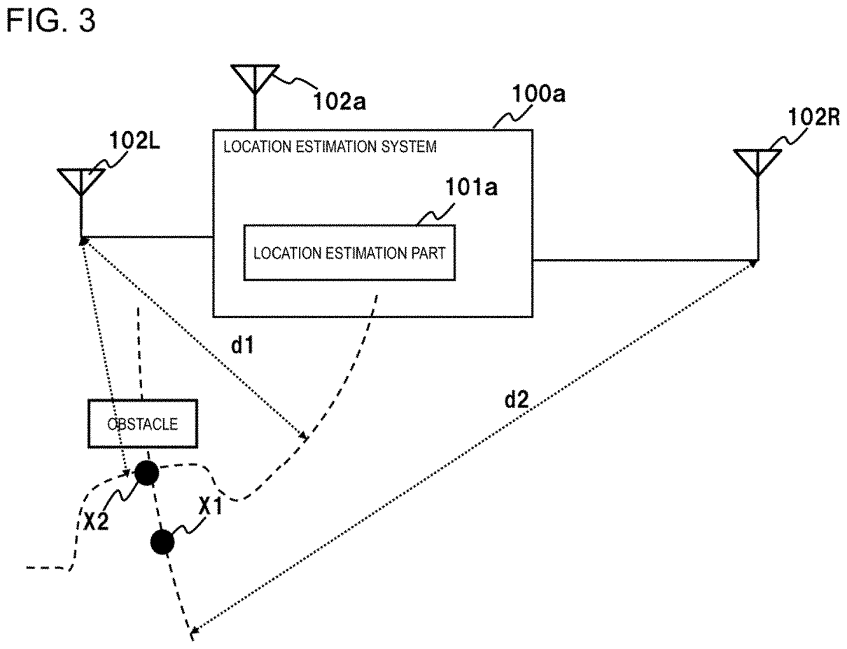

However, in an actual multipath environment, there are also various other conditions that fluctuate the reception strengths. Thus, since it is rare that the position of the radio wave transmission source 200a can be uniquely determined, and the location needs to be estimated in consideration of the impact of multipath fading. The following description will be made assuming that, as illustrated in FIG. 3, there is an obstacle between the radio wave sensor 102L and the radio wave transmission source 200a in FIG. 1. When the location estimation part 101a according to the present exemplary embodiment receives an unknown radio wave from the radio wave sensor 102L, the location estimation part 101a estimates the distance d1 between the radio wave sensor 102L and the radio wave transmission source 200a from the reception strength of the unknown radio wave by using the propagation models of the plurality of sub-areas. Namely, the distance d1 varies depending on the direction from the radio wave sensor 102L. In this case, the distance d1 is estimated in consideration of the existence of the obstacle as indicated by a dashed line in FIG. 3. Likewise, when the location estimation part 101a receives an unknown radio wave from the radio wave sensor 102R on the right side, the location estimation part 101a estimates the distance d2 between the radio wave sensor 102R and the radio wave transmission source 200a from the reception strength of the unknown radio wave by using the propagation models of the plurality of sub-areas. In this case, the location estimation part 101a estimates that the radio wave transmission source 200a exists at a point X2 in consideration of the existence of the obstacle, not at the intersection point X1 in FIG. 2.

As described above, according to the present exemplary embodiment, even in a multipath environment, the location of a radio wave transmission source can be estimated accurately. In addition, the data transfer amount and the operation amount can be made significantly less than those according to the techniques in NPLs 1 and 2 and PTLs 1 and 2.

### First Exemplary Embodiment

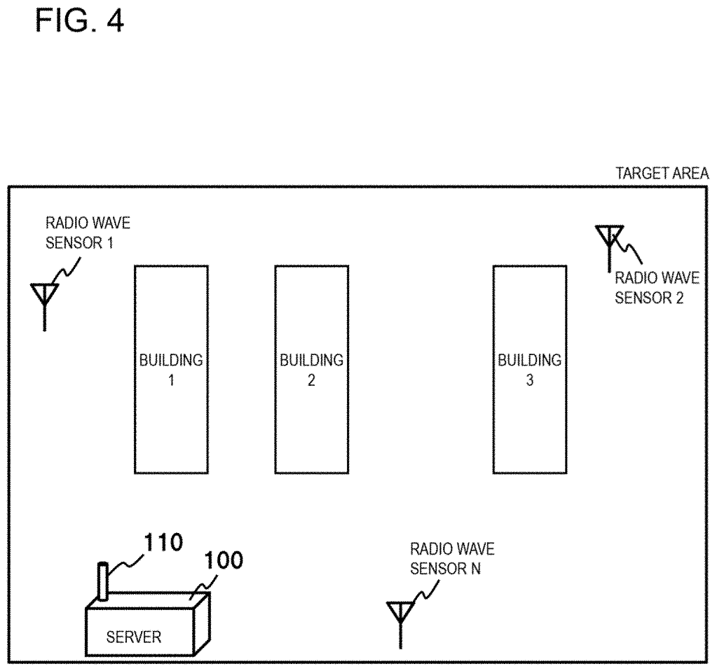

Next, a first exemplary embodiment of the present invention will be described in detail with reference to drawings. FIG. 4 illustrates a configuration according to the first exemplary embodiment of the present invention. FIG. 4 illustrates a configuration including a number N of radio wave sensors 1 to N placed in a target area in which the location of a radio wave transmission source is estimated and a server 100 including data reception means 110 for receiving data from the radio wave sensors 1 to N.

The radio wave sensors 1 to N receive radio waves of a detection target frequency and record the reception strengths of the radio waves. The radio wave sensors 1 to N are synchronized with each other in time and transfer the reception strengths along with time information to the server 100.

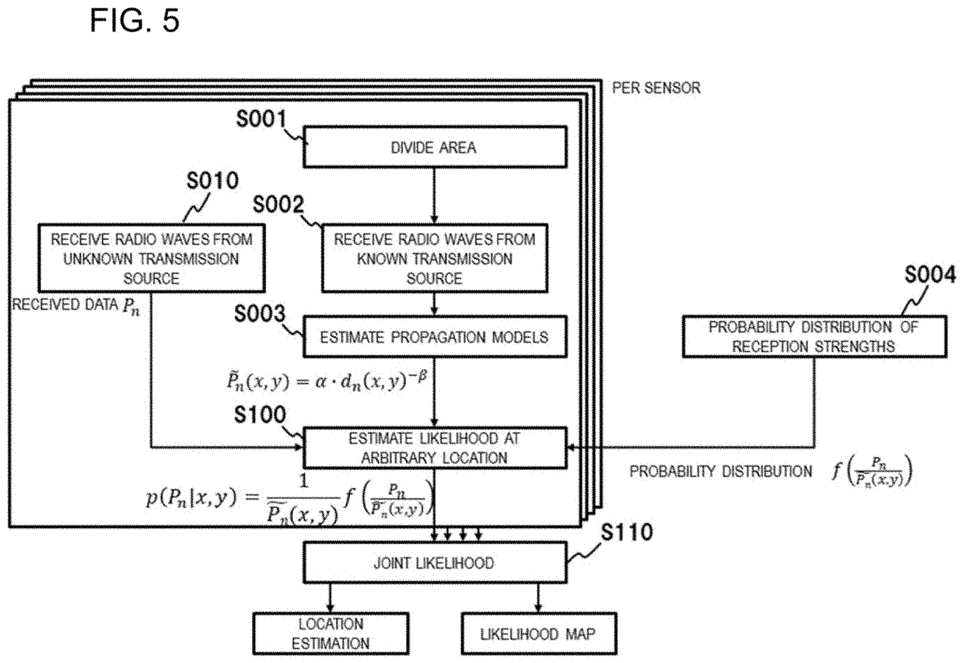

The server 100 corresponds to the above location estimation system. When receiving data of the reception strength via the data reception means 110, the server 100 performs location estimation processing and processing for creating propagation models and probability distribution models (probability density distributions) used in the location estimation processing. The contents of the above processing will be described in detail below with reference to FIGS. 5 to 8.

The radio wave sensors 1 to N according to the present exemplary embodiment measure the radio wave strengths of received radio waves with a predetermined sampling period. The radio wave sensors 1 to N according to the present exemplary embodiment calculate an average value of reception strengths per predetermined time interval (per second, for example) as the data of the reception strengths and transmits the average value to the server 100. In this way, the data transfer amount can be reduced.

The following description assumes an example in which the radio wave sensors 1 to N monitor radio waves in the 2.4 GHz frequency band. In this case, if the radio waves are measured with the sampling frequency of tens of megahertz (MHz) by using an IQ signal (In-Phase/Quadrature-Phase signal), the number of data samples per second reaches several tens of millions. If a technique using the TDoA is used, this data needs to be transferred to an analysis server, and the amount of the data is very large. In contrast, according to the present exemplary embodiment, for example, if the radio wave sensors 1 to N transfer an average value of reception strengths per second, the data transfer amount can be reduced up to one sample per second. Thus, the data transfer amount can be reduced by a factor of tens of millions, compared with use of a technique using the TDoA. In addition, this reduction in the data transfer amount enables data transfer in wireless communications instead of wired communications that impose limitations in installation location and improves the freedom in the installation locations of the radio wave sensors.

Next, a flow of estimating the location of the radio wave transmission source by the server according to the first exemplary embodiment of the present invention will be described. FIG. 5 illustrates a flow of estimating the location of the radio wave transmission source by the server 100 according to the first exemplary embodiment of the present invention.

### Division of Area

First, a location estimation target area is divided into sub-areas based on a relative positional relationship between the location of an individual radio wave sensor and a building(s) in the target area (step S001).

FIG. 6 illustrates an example of division of a target area according to the fifth exemplary embodiment of the present invention. In this example, a target area is divided for the radio wave sensor 1. In the example in FIG. 6, the target area is divided into sub-areas SA1 to SA4, and an individual sub-area is set based on the number of buildings between this sub-area and the radio wave sensor 1. Namely, there is no building between the sub-area SA1 and the radio wave sensor 1, and there is one building between the sub-area SA2 and the radio wave sensor 1. In addition, there are two buildings between the sub-area SA3 and the radio wave sensor 1, and there are three buildings between the sub-area SA4 and the radio wave sensor 1.

As described above, the division of a target area could change depending on the relative positional relationship between the location of an individual radio wave sensor and a building(s) in the target area. FIG. 7 illustrates another example of the division of the target area. In this example, the target area is divided for the radio wave sensor 2. In the example in FIG. 7, the target area is divided into sub-areas SA11 to SA14, and an individual sub-area is set based on the number of buildings between this sub-area and the radio wave sensor 2. Namely, there is no building between the sub-area SA11 and the radio wave sensor 2, and there is one building between the sub-area SA12 and the radio wave sensor 2. In addition, there are two buildings between the sub-area SA13 and the radio wave sensor 2, and there are three buildings between the sub-area SA14 and the radio wave sensor 2.

The server 100 may be configured to perform the above area division processing by receiving topographic data of the target area and location information about the radio wave sensors. Of course, an operator may enter division lines with reference to a map of the target area displayed on a display or the like and store the division lines in the server 100. While the target area includes three buildings as obstacles in the examples in FIGS. 6 and 7, the number of buildings is not limited to 3. The area division may be performed in consideration of other structures or topographic features that could affect the reception strengths of radio waves.

### Creation of Propagation Models

Next, a propagation model is created for each of the sub-areas obtained by dividing the target area. Sub-areas are set for an individual radio wave sensor. These propagation models are created as follows. First, a known radio wave transmission source is moved in the target area, and an individual radio wave sensor receives radio waves (step S002). Simultaneously, the location of the radio wave transmission source is acquired, and the distance between the radio wave transmission source and an individual radio wave sensor is calculated. Next, the measured values of the reception strengths received by the individual radio wave sensor are classified according to the sub-area in which the radio wave transmission source has existed. Next, a relationship between the reception strengths and the distance between the radio wave transmission source and the individual radio wave sensor per sub-area is obtained.

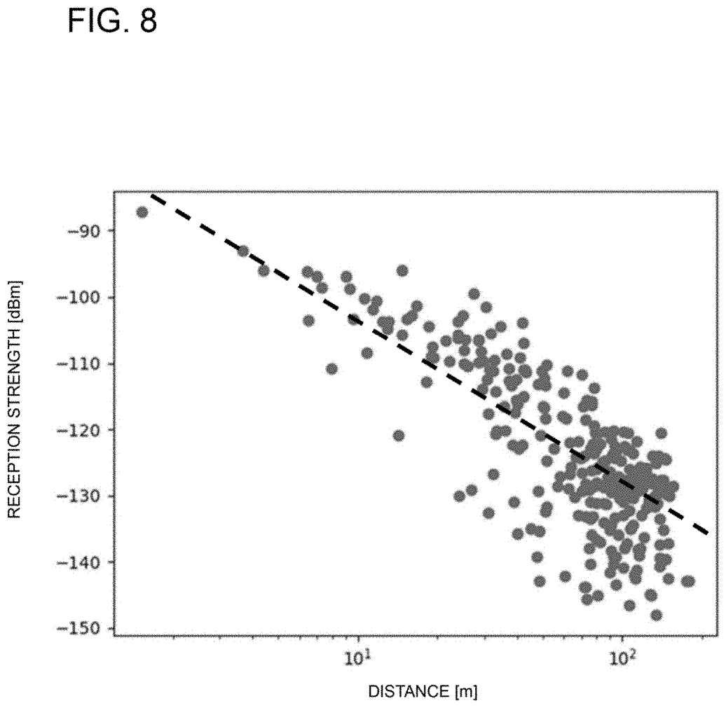

FIG. 8 is an example of a graph representing a relationship between the reception strengths and the distance between the radio wave transmission source and an individual radio wave sensor in a sub-area. Since sub-areas are set per radio wave sensor, a graph as illustrated in FIG. 8 is obtained for each of the sub-areas for the individual radio wave sensors. The server 100 creates a propagation model for each of the sub-areas of the individual radio wave sensors from the data as described above.

According to the present exemplary embodiment, a propagation model expressed by the following [Math 1] is used. In [Math 1], (x,y) represents the position coordinate of a radio wave transmission source, and (xₙ,yₙ) represents the position coordinate of the radio wave sensor n. In addition, dₙ(x,y) represents the distance between the radio wave sensor n and the radio wave transmission source, and (α,β) represents propagation constants. By fitting the measured values of the reception strengths and the distance between the radio wave transmission source and a radio wave sensor to [Math 1] by using a least-square method or the like, the propagation constants (α,β) can be obtained (step S003). In [Math 1], a dot “·” represents a multiplication operator.

\tilde{P}ₙ(x,y)=α·dₙ(x,y^{-β}

dₙ(x,y)=\sqrt{(x−xₙ)²−(y−yₙ)²} [Math 1]

### Probability Distributions of Reception Strengths

A dashed line in FIG. 8 represents a propagation model obtained by assigning the propagation constants obtained as a result of the above fitting to [Math 1]. The measured values indicated by points in FIG. 8 are dispersedly distributed from this propagation model. This is because, in radio wave propagation, in addition to direct waves from a transmitter to a receiver (a radio wave sensor), reflected waves from buildings, the ground, moving vehicles, people, etc. arrive at the receiver, and the reception strength significantly fluctuates due to various minute changes of locational or surrounding situations. Thus, in the present exemplary embodiment, the impact of the multipath fading is modeled with probability distributions.

If actually measured data Pₙ is normalized by a numerical value tilde(Pₙ(x,y)) obtained from the propagation model of [Math 1], [Math 2] can be calculated as a probability density distribution of the normalized reception strengths (step S004 in FIG. 5). In [Math 2], tilde(Pₙ(x,y)) represents the value of the left side of the upper expression in [Math 1].

$$f ( \frac{{P}_{n}}{{\tilde{P}}_{n} ( x , y )} ) \qquad [ Math 2 ]$$

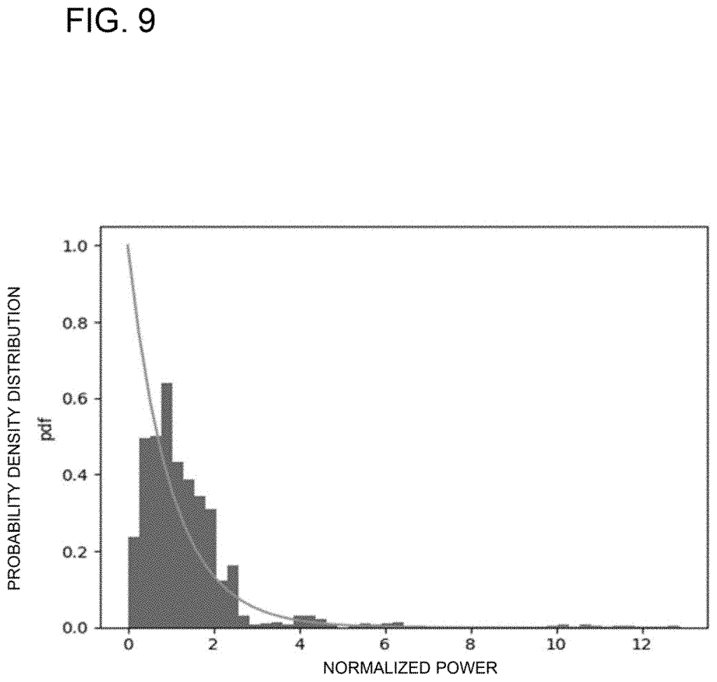

As a representative case, a multipath fading environment in which no prominent direct waves are present and many scattered waves alone are received is referred to as a Rayleigh fading environment. It is known that the probability density distribution of physical amounts obtained by raising the reception strengths of these waves to the second power represents an exponential function. Another representative case is a situation in which, for example, a stationary wave such as a line-of-sight wave (a direct wave) is added to the Rayleigh fading environment. It is known that a probability density distribution of radio wave strengths in this case represents a Nakagami-Rice distribution. For simplicity, the present exemplary embodiment assumes Rayleigh fading for all the sub-areas of all the radio wave sensors and that an exponential function is used as the distribution function of the probability density distribution [Math 2] (see FIG. 9).

### Likelihood Estimation at Arbitrary Location

As described above, the location of an unknown radio wave transmission source can be estimated. The server 100 estimates the location of an unknown radio wave transmission source by using the above propagation models and probability density distributions (probability distribution models) of reception strengths. Specifically, the server 100 receives radio waves from an unknown transmission source via the individual radio wave sensors 1 to N (step S010 in FIG. 5). Assuming that Pₙ represents the strengths of the radio waves received by the radio wave sensor n, the likelihood p(Pₙ|x,y) that the transmission source exists at an arbitrary location (x,y) in the target area can be calculated by the following [Math 3] (step S100 in FIG. 5).

$$p ( Pn \vert x , y ) = \frac{1}{{\tilde{P}}_{n} ( x , y )} f ( \frac{{P}_{n}}{{\tilde{P}}_{n} ( x , y )} ) \qquad [ Math 3 ]$$

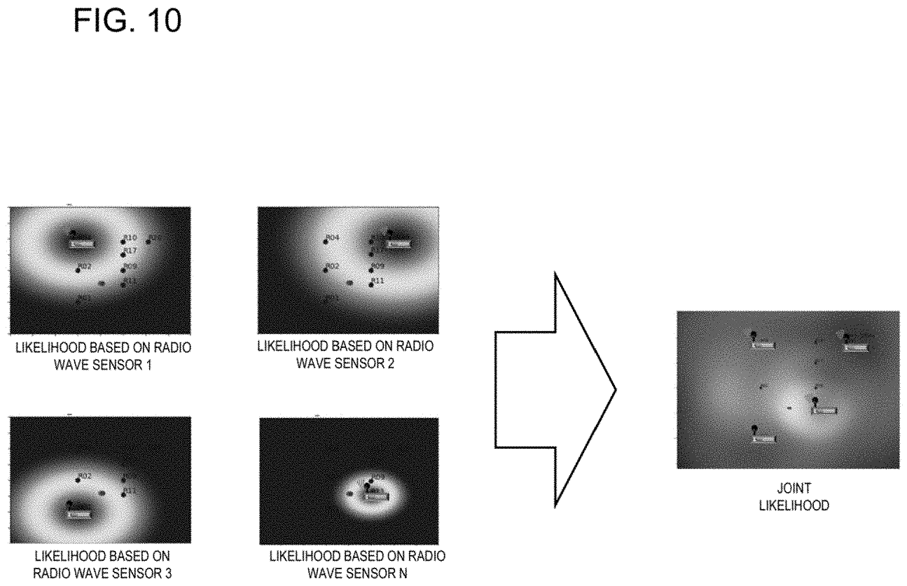

By repeating the calculation of the likelihood that the radio wave transmission source exists at the above arbitrary location, a transmission source location likelihood distribution in the target area is obtained per radio wave sensor. The likelihoods based on the radio wave sensors 1 to N on the left side in FIG. 10 represent the likelihood distributions obtained in the present step, and lighter-colored portions represent higher likelihoods. By multiplying these likelihood distributions based on the radio wave sensors, a joint likelihood distribution in consideration of all the radio wave sensors is obtained (step S110 in FIG. 5). The joint likelihood on the right side in FIG. 10 represents the joint likelihood distribution obtained in the present step, and lighter-colored portions represent higher likelihoods. This joint likelihood distribution can be used as a likelihood map of the location of the radio wave transmission source. Simultaneously, the location indicating the highest likelihood in the target area is the estimated location of the transmission source (location estimation).

As described above, according to the present exemplary embodiment, radio wave sensors measure radio waves of a known radio wave transmission source in a target area, and based on results of the measurement, propagation models in consideration of an obstacle(s) such as a building(s) in the target area can be created. In addition, according to the present exemplary embodiment, by using these propagation models and reception strength probability distributions, the location of an unknown radio wave transmission source can be accurately estimated.

According to the first exemplary embodiment, while an exponential function is used as the distribution function of the individual probability density distribution, the first exemplary embodiment is not limited to this example. Another distribution function such as the Nakagami-Rice distribution may be used. Instead of the function expression, data obtained in the process of the reception of the radio waves from the known radio wave transmission source may be used. Namely, the normalized received power of the actually measured data obtained from the known transmission source and the corresponding probability density distributions may be expressed in correspondence tables. In this case, when the likelihood estimation is performed, a probability density may be calculated with reference to the correspondence tables by using the reception strengths of radio waves from the unknown radio wave transmission source.

In the above first exemplary embodiment, the target area is divided into sub-areas based on the number of buildings with respect to an individual radio wave sensor as a reference. These target buildings can be determined based on the radio wave frequency. For example, when the radio wave frequency is low (when the wavelength is long), since the straightness of the radio waves is decreased, the radio waves arrive after diffracted. Thus, short buildings are not considered as obstacles. In contrast, when the radio wave frequency is high (when the wavelength is short), since the straightness of the radio waves is increased, the attenuation is large. Thus, even short buildings affect the reception strengths. Thus, it is preferable that the height of buildings taken into consideration when the target area is divided into sub-areas be changed depending on the target frequency.

### Second Exemplary Embodiment

Next, a second exemplary embodiment obtained by changing the above first exemplary embodiment will be described. Since the second exemplary embodiment can be realized by almost the same configuration as that of the first exemplary embodiment, the following description will be made with a focus on the difference.

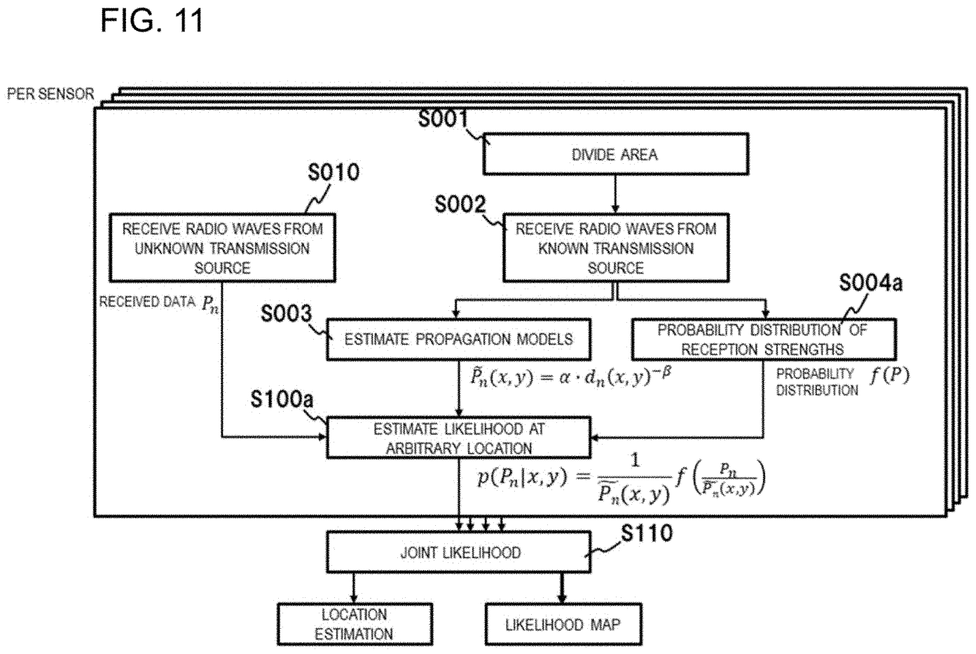

FIG. 11 illustrates a flow of estimating the location of a radio wave transmission source by a server 100 according to the second exemplary embodiment of the present invention. In the first exemplary embodiment, the probability density distribution of [Math 2] is used for all the radio wave sensors and all the sub-areas. However, in the present exemplary embodiment, a probability density distribution that takes, for example, the relative position between a sub-area and a radio wave sensor into consideration, is used for a corresponding one of the sub-areas for the individual radio wave sensors (see S004a; f(P) in FIG. 11).

For example, in the case of the division of the target area for the radio wave sensor 1 illustrated in FIG. 6, since there is no building between the sub-area SA1 and the radio wave sensor, direct waves arrive at the radio wave sensor. Thus, for this sub-area SA1, a Nakagami-Rice distribution may be used as the distribution function, and an exponential distribution may be used as the distribution function for the other areas.

Likewise, in the case of the radio wave sensors 2 and n, a Nakagami-Rice distribution may be used as the distribution function of the reception strength probability density distribution in the sub-areas where direct waves arrive, and an exponential distribution may be used for the other areas. While these distribution functions to be used are not particularly limited, for example, as described above, a different distribution function may selectively be used depending on whether direct waves (line-of-sight waves) arrive at the sub-area.

Thus, according to the second exemplary embodiment of the present invention, a distribution model that matches an actual radio wave propagation environment can be applied, and the accuracy in estimating the location of a radio wave transmission source can be improved. This is because a different probability density distribution can be used for each of the sub-areas for the individual radio wave sensors.

In the above example, distribution functions are used as the probability density distributions. However, as described lastly in the first exemplary embodiment, a probability density may be calculated by using correspondence tables obtained from actually measured data. In this case, by preparing a plurality of kinds of correspondence tables and selectively using a table per sub-area, the same advantageous effects as those of the modes using the above functions can be provided.

### Third Exemplary Embodiment

Next, a third exemplary embodiment obtained by changing the above first and second exemplary embodiments will be described. Since the third exemplary embodiment can be realized by almost the same configuration as that according to the first exemplary embodiment, the following description will be made with a focus on the difference.

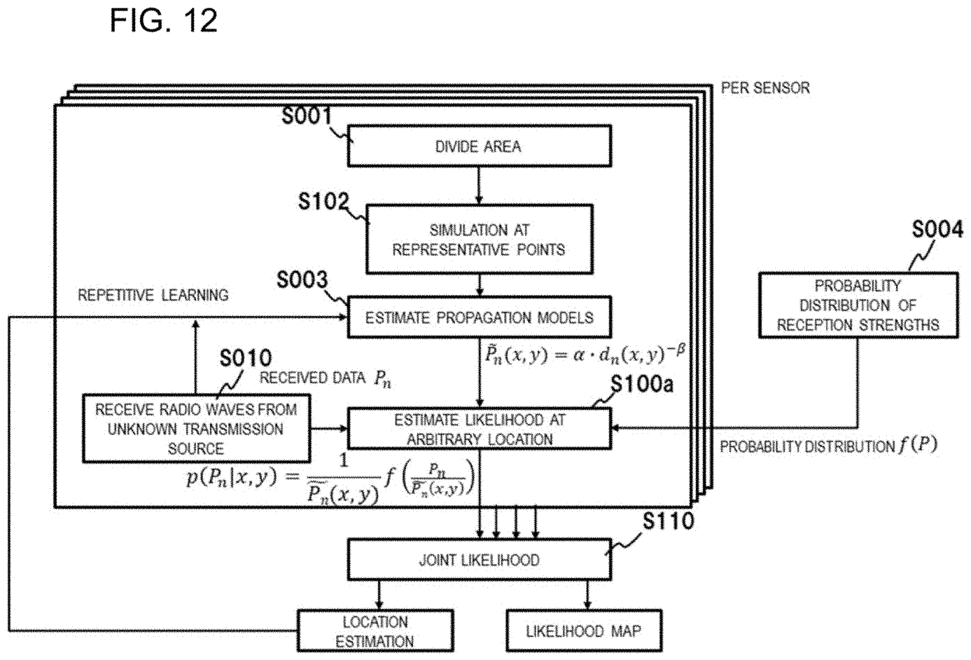

FIG. 12 illustrates a flow of estimating the location of a radio wave transmission source by a server 100 according a third exemplary embodiment of the present invention. According to the first and second exemplary embodiments, the propagation models are estimated in advance based on received data of radio waves from a known transmission source. However, according to the third exemplary embodiment, the propagation models are estimated without performing actual training in advance.

As illustrated in FIG. 12, first, a target area is divided into sub-areas per radio wave sensor (step S001), and a reception strength is estimated per sub-area (step S102). Consequently, the initial values of the propagation models are set. A ray tracing simulation may be used to estimate the reception strengths or propagation estimation expressions indicated in various literatures may be used. For example, NPL 3 indicates macro/micro propagation models about urban areas and suburban areas. By using these techniques, received power at several points is simulated per sub-area, and propagation models corresponding to the propagation model in [Math 1] are obtained (step S003).

According to the present exemplary embodiment, as in the first exemplary embodiment, a common distribution is used for each of the sub-areas for the individual radio wave sensors, as the reception strength probability density distribution (step S004). For example, as in the first exemplary embodiment, an exponential distribution may be used as the distribution function. When receiving radio waves from an unknown radio wave transmission source (step S010), the server 100 estimates the location of the unknown transmission source by using the above propagation models and the probability density distribution (steps S100a to S110). Next, based on the received radio wave strengths and the estimated location, the server 100 updates data corresponding to the individual graph in FIG. 8 as needed, and the propagation models are updated as needed by a least-square method (“repetitive learning” in FIG. 12).

Thus, the third exemplary embodiment of the present invention can improve the accuracy of the propagation models while operating the system for estimating the location of a radio wave transmission source.

While the above third exemplary embodiment has been described assuming that only the propagation models are updated by repetitive learning, the reception strength probability distribution can also be updated in the same way. In addition, regarding the reception strength probability distribution, by updating a different probability density distribution for each of the sub-areas of the radio wave sensors and by using these distributions for estimating the likelihood of the location of a radio wave transmission source, the location estimation accuracy can be improved further as in the second exemplary embodiment.

### Fourth Exemplary Embodiment

Next, a fourth exemplary embodiment obtained by changing the division method of a target area into sub-areas according to the above first to third exemplary embodiments will be described. Since the fourth exemplary embodiment can be realized by almost the same configuration as that of the first to third exemplary embodiments, the following description will be made with a focus on the difference.

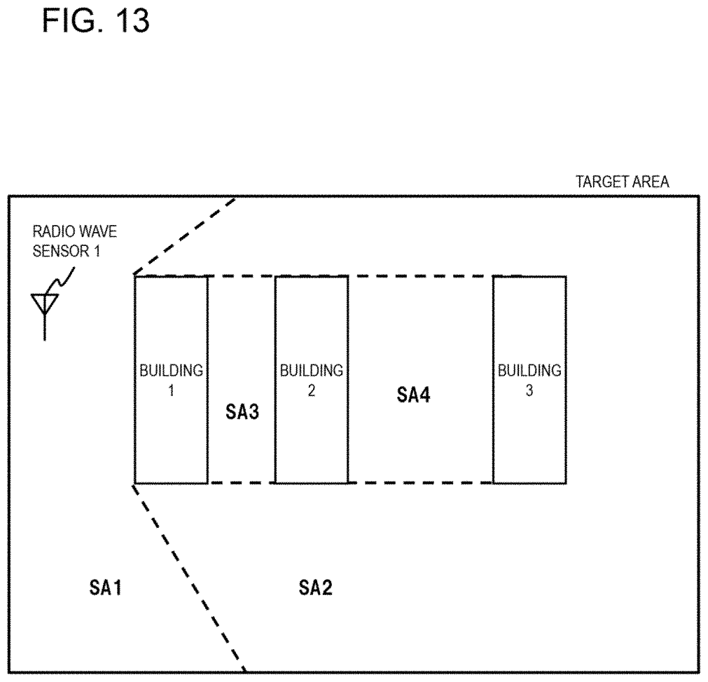

FIGS. 13 to 15 illustrate target area division methods according to the fourth exemplary embodiment. According to the division method illustrated in FIG. 13, a target area is divided into four sub-areas. In the example in FIG. 13, first, an area viewable from a radio wave sensor is set to be a sub-area SA1. Next, since, in an area between buildings, reflection and refraction caused by the buildings are dominant, the area between buildings 1 and 2 is set to be a sub-area A3. Likewise, the area between buildings 2 to 3 is set to be a sub-area SA4. In addition, an area that is behind a building(s) with respect to the radio wave sensor and that has no building behind the area is set to be a sub-area SA2.

The subsequent processing is the same as that according to the first to third exemplary embodiments. The server 100 performs the location estimation by selecting a propagation model and a probability distribution per sub-area. Regarding the probability distribution, as described in the second exemplary embodiment, a Nakagami-Rice distribution may be used as the distribution function for the sub-area SA1 where direct waves arrive at the radio wave sensor 1, and an exponential distribution may be used as the distribution function for the other sub-areas (particularly for the sub-areas SA3 and SA4).

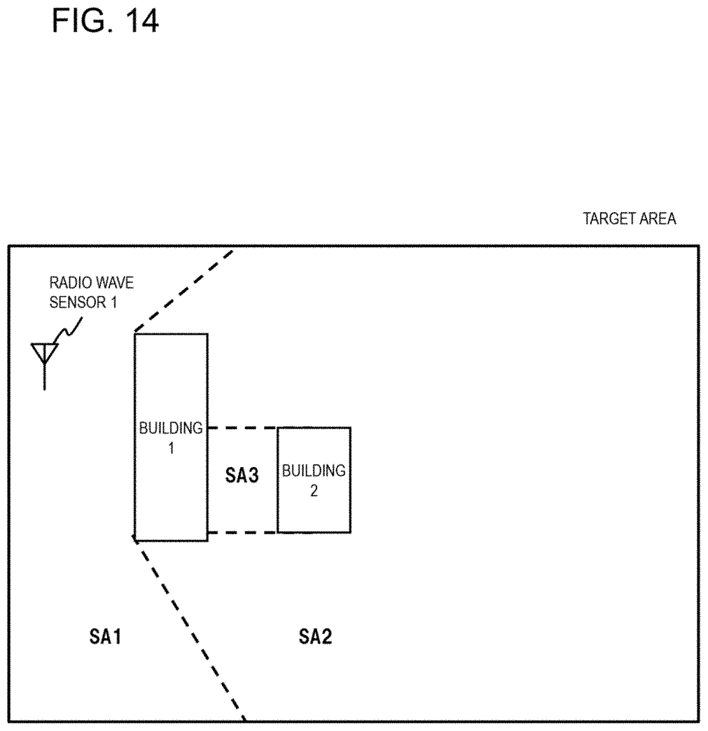

While the example in FIG. 13 has been described assuming that the target area includes buildings 1 to 3 of the same size, the target area may be divided into sub-areas depending on the sizes or heights of the buildings. For example, in the example in FIG. 14, from the viewpoint of the radio wave sensor 1, there is a building 2 behind the building 1, and this building 2 is smaller than the building 1. In this case, too, in the same way as described with reference to FIG. 13, first, an area viewable from a radio wave sensor 1 is set to be a sub-area SA1, and an area between the buildings 1 and 2 is set to be a sub-area SA3. In addition, an area that is behind the building(s) with respect to the radio wave sensor and that has no reflecting buildings behind the area is set to be a sub-area SA2.

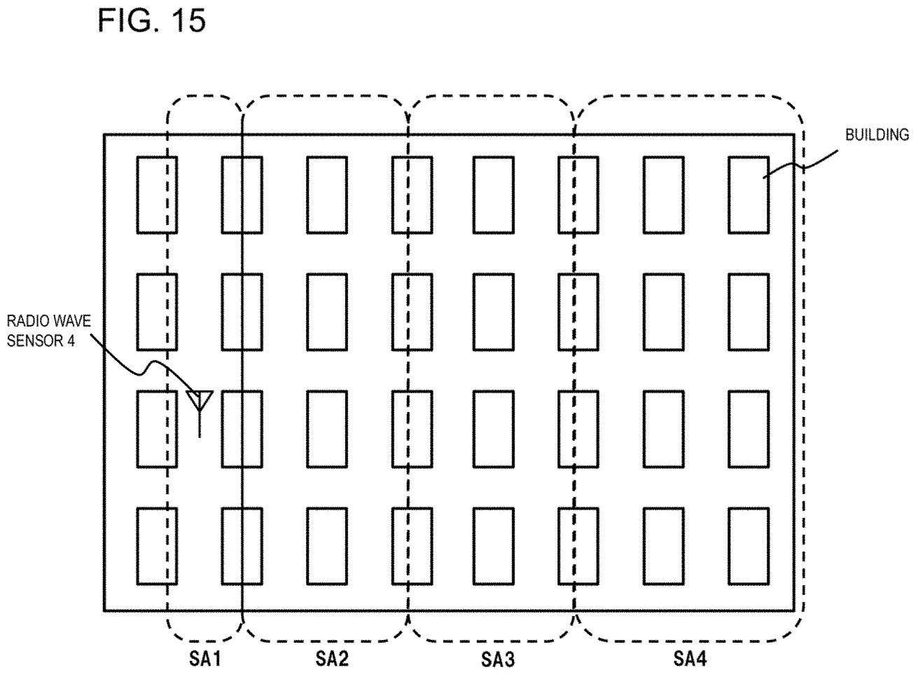

FIG. 15 illustrates an example of the division of a target area into sub-areas when many buildings are arranged in a grid pattern in the target area. In the example in FIG. 15, first, an area viewable from a radio wave sensor 4 is set to be a sub-area SA1, and an area including the first and second columns (streets) from the column (street) where the radio wave sensor 4 is placed is set to be a sub-area SA2. Likewise, an area including the third and fourth columns (streets) from the column (street) where the radio wave sensor 4 is placed is set to be a sub-area SA3. In addition, an area including the fifth to seventh columns (streets) from the column (street) where the radio wave sensor 4 is placed is set to be a sub-area SA4. In this way, the target area may be divided into sub-areas by using a rough number or arrangement of buildings or geographical features of the target area, instead of using the exact number of buildings, for example. When areas have similar numbers of blocking buildings, these areas have similar impacts of direct waves, diffracted waves, and reflected waves. Thus, since the propagation models and probability distributions are similar, such division method as described above is practical.

In addition, while the target area is divided to three or four sub-areas in the above examples, the division number of the target area is not limited 4. For example, when any one of the division methods as described with reference to FIGS. 6, 7, 13, and 14 is adopted, the number of sub-areas is equal to the number of buildings in the target area+1. Of course, the target area may be divided into sub-areas, for example, in consideration of the heights or the sizes of the buildings.

Thus, as described in the fourth exemplary embodiment, various methods can be adopted to divide a target area. Namely, an optimal division method can be adopted, for example, based on the location estimation accuracy demanded by the user or the processing capabilities of the server 100.

### Fifth Exemplary Embodiment

Next, a fifth exemplary embodiment obtained by changing the configuration of sub-areas will be described. Since the fifth exemplary embodiment can be realized by almost the same configuration as that of the first to fourth exemplary embodiments, the following description will be made with a focus on the difference.

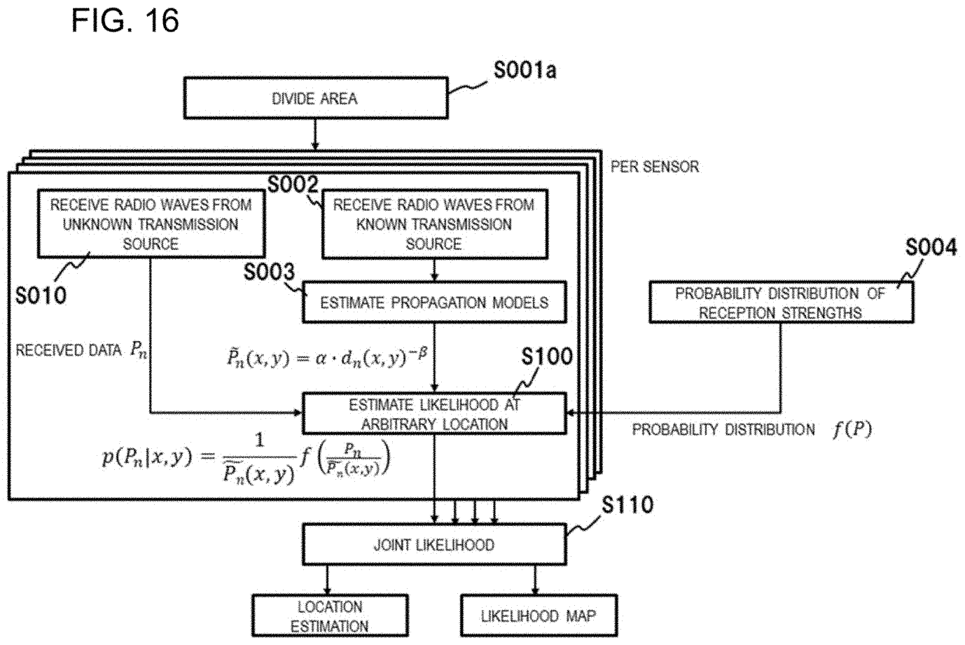

FIG. 16 illustrates a flow of estimating the location of a radio wave transmission source by a server 100 according to a fifth exemplary embodiment of the present invention. In the first to fourth exemplary embodiments, a target area is divided per radio wave sensor. However, in the present exemplary embodiment, a target area is commonly divided for all the radio wave sensors (see S001a in FIG. 16), and a propagation model is estimated for each of the sub-areas of the individual radio wave sensors.

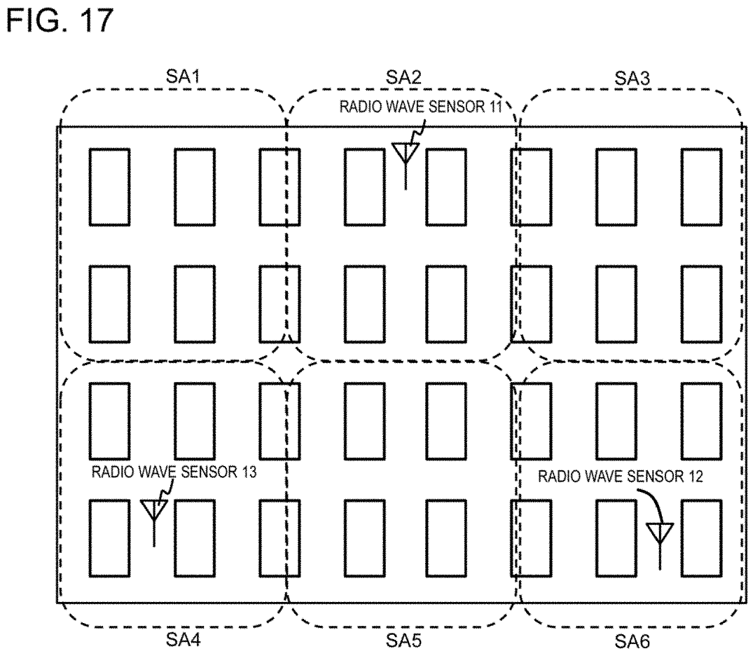

FIG. 17 illustrates an example of the division of a target area in step S001a in FIG. 16. In the example in FIG. 17, the target area is divided into areas (blocks) close to each other, and these areas (blocks) will be referred to as sub-areas SA1 to SA6. The subsequent operations can be performed in the same way as those according to the first to third exemplary embodiments. Specifically, an individual radio wave sensor estimates a propagation model per sub-area. For example, in the case of a radio wave sensor 11 in FIG. 17, the sub-area SA2 close to the radio wave sensor, the impact of direct waves is strong. However, from the sub-areas SA4 and SA6 far away from the radio wave sensor, almost no direct waves arrive at the radio wave sensor 11. Propagation models and probability density distributions that take these differences into consideration are applied. According to the present exemplary embodiment, too, the estimation accuracy can be improved by calculating a propagation model and a probability density distribution (a probability distribution model) per sub-area.

While the above exemplary embodiments of the present invention have been described, the present invention is not limited thereto. Further modifications, substitutions, or adjustments can be made without departing from the basic technical concept of the present invention. For example, the configurations of networks and elements and the representation modes of messages illustrated in the individual drawings are merely used as examples to facilitate the understanding of the present invention. Thus, the present invention is not limited to the configurations illustrated in the drawings. In addition, “A and/or B” in the following description signifies at least one of A and B.

For example, in the above exemplary embodiments, the location estimation is performed by creating a preferable propagation model per sub-area. However, the location estimation may be performed by creating a preferable probability distribution model per sub-area. In this case, a propagation model may commonly be used among all the sub-areas (a mode in which a preferable propagation model is created per sub-area corresponds to the second exemplary embodiment).

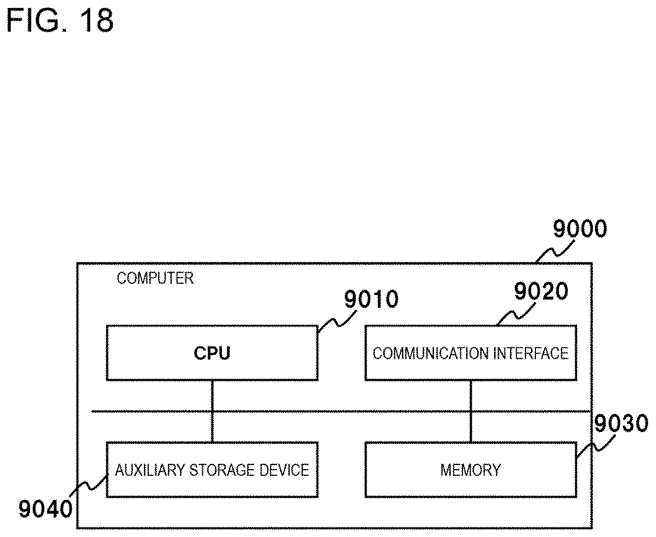

The procedures according to the above first to fifth exemplary embodiments can be realized by a program that causes a computer (9000 in FIG. 18) that functions as the corresponding server 100 to realize the functions of the server 100. For example, this computer includes a central processing unit (CPU) 9010, a communication interface 9020, a memory 9030, and an auxiliary storage device 9040 in FIG. 18. Namely, the program may cause the CPU 9010 in FIG. 18 to execute an area division program and a location estimation program and to perform processing for updating the individual calculation parameters stored in the auxiliary storage device 9040, etc.

Namely, the individual parts (processing means, functions) of the server 100 according to the above first to fifth exemplary embodiments may be realized by a computer program that causes a processor included in the server 100 to perform the individual processing described above by using its hardware.

Finally, suitable modes of the present invention will be summarized.

### Mode 1

(See the location estimation system according to the above first aspect)

### Mode 2

The location estimation part in the location estimation system may calculate a distribution of likelihoods that the radio wave transmission source exists in the predetermined area per radio wave sensor and estimate the location of the radio wave transmission source from a joint likelihood distribution obtained by integrating the likelihood distributions.

### Mode 3

The location estimation part in the location estimation system may estimate the location of the radio wave transmission source based on the distance between the radio wave transmission source and the individual radio wave sensor estimated by using the plurality of radio wave sensors.

### Mode 4

In the above location estimation system, it is preferable that an individual one of the sub-areas for a radio wave sensor be set by dividing the predetermined area according to the number of obstacles present between this sub-area and this radio wave sensor in the predetermined area.

### Mode 5

In the above location estimation system, it is preferable that an individual one of the sub-areas for an individual radio wave sensor be set depending on whether this sub-area is viewable by this radio wave sensor, that, if a sub-area is viewable by the radio wave sensor, a Nakagami-Rice distribution be applied as a distribution function of a probability distribution model in the sub-area, and that an exponential distribution be applied as a distribution function of a probability distribution model for a different sub-area(s).

### Mode 6

In the above location estimation system, it is preferable that an individual one of the sub-areas for an individual radio wave sensor be set depending on whether this sub-area is between buildings in the predetermined area and that, if a sub-area(s) is between buildings, an exponential distribution be applied as a distribution function of a probability distribution model for the sub-area(s).

### Mode 7

In the above location estimation system, it is preferable that an individual one of the sub-areas for a radio wave sensor be set by dividing the predetermined area according to the distance from the radio wave sensor.

### Mode 8

In the above location estimation system, the propagation models may be created by measuring power received from a radio wave transmission source whose location is known.

### Mode 9

In the above location estimation system, the propagation models may be updated by learning received power of radio waves received from the radio wave transmission source and the estimated location.

### Mode 10

In the above location estimation system, the probability density distributions set for the respective sub-areas may be used as the probability density distributions of the radio wave strengths.

### Mode 11

(See the location estimation system according to the above second aspect)

### Mode 12

(See the location estimation method according to the above third aspect)

### Mode 13

(See the program according to the above fourth aspect)

The above modes 11 to 13 can be expanded in the same way as mode 1 is expanded to modes 2 to 10.

The disclosure of each of the above PTLs and NPLs is incorporated herein by reference thereto. Variations and adjustments of the exemplary embodiments and examples are possible within the scope of the overall disclosure (including the claims) of the present invention and based on the basic technical concept of the present invention. Various combinations and selections (including partial deletion) of various disclosed elements (including the elements in each of the claims, exemplary embodiments, examples, drawings, etc.) are possible within the scope of the disclosure of the present invention. Namely, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

### INDUSTRIAL APPLICABILITY

The present invention is applicable not only to a location estimation system of illegal radio wave sources but also to a location estimation system of self-driving machines such as drones and a location estimation system of missing people.

### REFERENCE SIGNS LIST

1 to N, 102a, 102L, 102R radio wave sensor
100a location estimation system
101a location estimation part
100 server
110 data reception means
200a radio wave transmission source
SA1 to SA4, SA11 to SA14 sub-area
9000 computer
9010 CPU
9020 communication interface
9030 memory
9040 auxiliary storage device

What is claimed is:

1. A location estimation system, comprising:
a location estimation part that estimates a location of a radio wave transmission source by using radio wave strengths received by a plurality of radio wave sensors dispersedly placed in a predetermined area, propagation models, each of which represents a relationship between radio wave strengths and distance, and probability distribution models of the radio wave strengths;
wherein the location estimation part estimates the location of the radio wave transmission source by using the propagation model set for an individual sub-area obtained by dividing the predetermined area based on locations of the radio wave sensors in the predetermined area and placement of an obstacle(s) in the predetermined area.

2. The location estimation system according to claim 1; wherein an individual one of the sub-areas for a radio wave sensor is set by dividing the predetermined area according to the number of obstacles present between this sub-area and this radio wave sensor in the predetermined area.

3. The location estimation system according to claim 1;
wherein an individual one of the sub-areas for an individual radio wave sensor is set depending on whether this sub-area is viewable by this radio wave sensor;
wherein a Nakagami-Rice distribution is applied as a distribution function of a probability distribution model in the sub-area viewable by the radio wave sensor; and
wherein an exponential distribution is applied as a distribution function of a probability distribution model for a different sub-area(s).

4. The location estimation system according to claim 1;
wherein an individual one of the sub-areas for an individual radio wave sensor is set depending on whether this sub-area is between buildings in the predetermined area; and
wherein, if a sub-area(s) is between buildings, an exponential distribution is applied as a distribution function of a probability distribution model for the sub-area(s).

5. The location estimation system according to claim 1; wherein the propagation models are created by measuring power received from a radio wave transmission source whose location is known.

6. The location estimation system according to claim 1; wherein the propagation models are updated by learning received power of radio waves received from the radio wave transmission source and the estimated location.

7. The location estimation system according to claim 1; wherein the probability distribution models set for the respective sub-areas are used as the probability distribution models of the radio wave strengths.

8. A location estimation system, comprising:
a location estimation part that estimates a location of a radio wave transmission source by using radio wave strengths received by a plurality of radio wave sensors dispersedly placed in a predetermined area, propagation models, each of which represents a relationship between radio wave strengths and distance, and probability distribution models of the radio wave strengths;
wherein the location estimation part estimates the location of the radio wave transmission source by using the probability distribution model set for an individual sub-area obtained by dividing the predetermined area based on locations of the radio wave sensors in the predetermined area and placement of an obstacle(s) in the predetermined area.

9. A method for estimating a location of a radio wave transmission source, the method comprising:
causing a computer, which estimates a location of a radio wave transmission source by using radio wave strengths received by a plurality of radio wave sensors dispersedly placed in a predetermined area, propagation models, each of which represents a relationship between radio wave strengths and distance, and probability distribution models of the radio wave strengths, to estimate a location of a radio wave transmission source by using a propagation model set for an individual sub-area obtained by dividing the predetermined area based on locations of the radio wave sensors in the predetermined area and placement of an obstacle(s) in the predetermined area.

10. (canceled)

11. The location estimation system according to claim 8; wherein an individual one of the sub-areas for a radio wave sensor is set by dividing the predetermined area according to the number of obstacles present between this sub-area and this radio wave sensor in the predetermined area.

12. The location estimation system according to claim 8;
wherein an individual one of the sub-areas for an individual radio wave sensor is set depending on whether this sub-area is viewable by this radio wave sensor;
wherein a Nakagami-Rice distribution is applied as a distribution function of a probability distribution model in the sub-area viewable by the radio wave sensor; and
wherein an exponential distribution is applied as a distribution function of a probability distribution model for a different sub-area(s).

13. The location estimation system according to claim 8;
wherein an individual one of the sub-areas for an individual radio wave sensor is set depending on whether this sub-area is between buildings in the predetermined area; and
wherein, if a sub-area(s) is between buildings, an exponential distribution is applied as a distribution function of a probability distribution model for the sub-area(s).

14. The location estimation system according to claim 8; wherein the propagation models are created by measuring power received from a radio wave transmission source whose location is known.

15. The location estimation system according to claim 8; wherein the propagation models are updated by learning received power of radio waves received from the radio wave transmission source and the estimated location.

16. The location estimation system according to claim 8; wherein the probability distribution models set for the respective sub-areas are used as the probability distribution models of the radio wave strengths.

17. The method for estimating a location of a radio wave transmission source according to claim 9; wherein an individual one of the sub-areas for a radio wave sensor is set by dividing the predetermined area according to the number of obstacles present between this sub-area and this radio wave sensor in the predetermined area.

18. The method for estimating a location of a radio wave transmission source according to claim 9;
wherein an individual one of the sub-areas for an individual radio wave sensor is set depending on whether this sub-area is viewable by this radio wave sensor;
wherein a Nakagami-Rice distribution is applied as a distribution function of a probability distribution model in the sub-area viewable by the radio wave sensor; and
wherein an exponential distribution is applied as a distribution function of a probability distribution model for a different sub-area(s).

19. The method for estimating a location of a radio wave transmission source according to claim 9;
wherein an individual one of the sub-areas for an individual radio wave sensor is set depending on whether this sub-area is between buildings in the predetermined area; and
wherein, if a sub-area(s) is between buildings, an exponential distribution is applied as a distribution function of a probability distribution model for the sub-area(s).

20. The method for estimating a location of a radio wave transmission source according to claim 9; wherein the propagation models are created by measuring power received from a radio wave transmission source whose location is known.

21. The method for estimating a location of a radio wave transmission source according to claim 9; wherein the propagation models are updated by learning received power of radio waves received from the radio wave transmission source and the estimated location.
